(19) United States
(12) Patent Application Publication
(10) Pub. No.: US 2008/0263542 A1
(43) Pub. Date: Oct. 23, 2008

(54) Software-Firmware Transfer System

(75) Inventors: Simon B. Johnson, Bonney Lake, WA (US); Lev M. Bolotin, Kirkland, WA (US)

Correspondence Address: LAW OFFICES OF MIKIO ISHIMARU, 333 W. EL CAMINO REAL, SUITE 330, SUNNYVALE, CA, 94087, US

(73) Assignee: CLEVX, LLC, Kirkland, WA (US)

(21) Appl. No.: 12/089,817

(22) PCT Filed: Oct. 12, 2006
(86) PCT No.: PCT/US2006/040302

§ 371 Date: Apr. 10, 2008

Related U.S. Application Data
(60) Provisional application No. 60/726,131, filed on Oct. 12, 2005.
(60) Provisional application No. 60/766,280, filed on Jan. 7, 2006.

(51) Int. Cl. G06F 9/445; G06F 12/00

(52) U.S. Cl. 717/174; 711/170; 711/E12.001

(57) ABSTRACT

A software and/or hardware transfer system is provided including: reading hidden computing device identification; reading computing device identification; and installing or uninstalling software only when the hidden computing device identification and the computing device identification from the computing device match or the hidden computing device identification is blank.

### TECHNICAL FIELD

The present invention relates generally to software and/or firmware protection, and more particularly to systems for eliminating unauthorized software and/or firmware distribution or piracy.

### BACKGROUND ART

The use of personal computers in both the home and in the office has become commonplace. Personal computers provide a high level of functionality at a moderate price, substantially surpassing the performance of large mainframe computers of a short while ago. Now, laptop and notebook computers, which provide high-performance computing power on a mobile basis, are becoming increasingly more common.

To make use of the increasing computing power that is becoming available, ever more complex and multi-functional software and firmware (generally referred to as software) have and are being developed. Many thousands, if not millions, of man-hours are being invested in creation and testing of new software. To be able to obtain a return on the development program costs, the software must be sold at high prices.

Due to the cost of the software and the ease of copying, an extensive network of copiers or software pirates has evolved. Although unauthorized copying or use of software is a violation of the law, the widespread availability of pirated software cost developers billions of U.S. dollars.

Software and computer developers have both long sought technical solutions to software piracy and many different systems have been tried with limited success.

One solution uses an external device known as a hardware key, or “dongle”, coupled to an input/output port of a host computer. Unfortunately, dongles are expensive and/or troublesome to use so their use has been substantially limited to high value software.

Another solution involves online activation over the Internet to verify a legitimate authentication key provided with the software. Both secret key encryption, such as DES (Data Encryption Standard), and public key that use a public and a private key have been tried. However, key encryption does not protect the receiver of the activation code because it does not allow the recipient to authenticate the validity of the key or the identity of the sender.

Still another solution has been the development of authentication keys created based on a computing device network card identification, such as a smart card. However, the smart card requires a smart card reader, which is additional extraneous equipment.

These solutions have not been entirely successful or accepted. Companies, like Microsoft, lose billions of U.S. dollars in revenues due to software and/or firmware piracy, and have continued to make significant investments in trying to prevent illegal copying, but with limited success.

Solutions to these problems have been long sought but prior developments have not taught or suggested any solutions and, thus, solutions to these problems have long eluded those skilled in the art.

### DISCLOSURE OF THE INVENTION

The present invention includes a software and/or firmware transfer system including: reading hidden computing device identification; reading computing device identification; and installing or uninstalling software only when the hidden computing device identification and the computing device identification from the computing device match or the hidden computing device identification is blank.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a flow chart for an install process for a software-firmware transfer system in an embodiment of the present invention;

FIG. 2 is a flow chart for an uninstall process for a software-firmware transfer system in an embodiment of the present invention;

FIG. 3 is a schematic of software-firmware transfer system using a separate software-firmware controlled delivery system and separate media in another embodiment of the present invention; and

FIG. 4 is a schematic of software-firmware transfer system using a software-firmware controlled delivery system with integrated software media in a further embodiment of the present invention.

### BEST MODE FOR CARRYING OUT THE INVENTION

The following embodiments are described in sufficient detail to enable those skilled in the art to make and use the invention, and it is to be understood that other embodiments would be evident based on the present disclosure and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

Likewise, the drawings showing embodiments of the apparatus/device are semi-diagrammatic and not to scale and, particularly, some of the dimensions are for the clarity of presentation and are shown greatly exaggerated in the drawing FIGs.

Generally, the device can be operated in any orientation. In addition, where multiple embodiments are disclosed and described having some features in common, for clarity and ease of illustration, description, and comprehension thereof, similar and like features one to another will ordinarily be described with like reference numerals.

The term “software-firmware transfer system” refers to a system, which in one of its functions eliminates unauthorized software and/or firmware distribution (piracy).

The term “software and/or firmware” refers to all types of files used to create an executable application and to firmware, databases, or other files that can be used in conjunction with an executable application.

The system may include a software-firmware controlled delivery system (SCDS), which is a device for controlling distribution of the software or firmware in accordance with the present invention. The SCDS is used during installation and/or removal of the software or firmware but does not need to be used during use of the software-firmware. An example of a SCDS is smart media, such as an USB Flash Drive.

The system solves several problems associated with software and/or firmware piracy and lost revenues:

1. Prevents copying a distribution disk & key to make counterfeit copies.

2. Prevents “borrowing” a distribution disk for software or firmware installation on another computing device of another user.

3. Improves manufacturing processes, as authentication keys do not have to be generated and tracked.

The system of the present invention is for use with “computing devices”, which can directly or indirectly use an executable application. This would include not only computers, but also devices such as personal digital assistants (PDAs), iPods, cellphones, etc.

It can also be used for distribution of software and/or firmware for embedded devices. For example, it can be used to deliver firmware for production equipment like testers (e.g. Agilent and Teradyne testers), programmers (e.g., Data I/O and BP Microsystems programmers, etc.), and embedded processor systems.

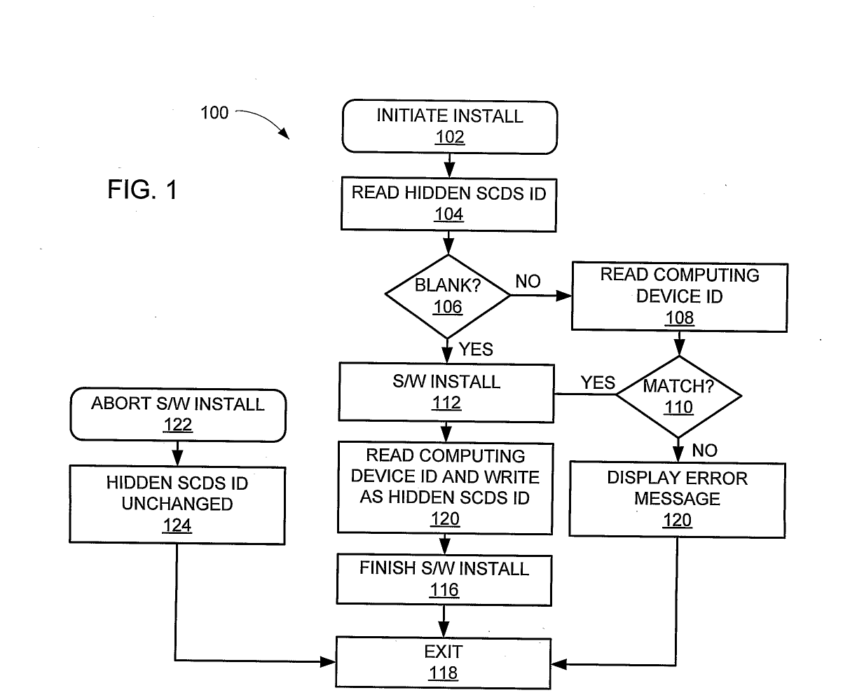

Referring now to FIG. 1, therein is shown a flow chart for an install process 100 for a software-firmware transfer system in an embodiment of the present invention. The install process 100 begins with initiate the install in a block 102. Next, the install process 100 reads a hidden SCDS ID in a block 104. The install process 100 then determines if a hidden computing device ID is blank in a block 106.

If the hidden SCDS ID is not blank, a computing device ID is read in a block 108. If the computing device ID and the hidden SCDS ID match in a block 110, the software is installed in a block 112.

After the software is installed in the block 112, the computing device ID is read from the computing device and written to the SCDS as the hidden SCDS ID in a block 114.

The software is finished installing in a block 116, and the install process 100 exits at a block 118.

If the IDs of the computing device and the SCDS do not match, an error message is displayed in a block 120, and then the program exits at the block 118.

If the operator aborts software install at a block 122, the hidden SCDS ID in the SCDS is unchanged in a block 124. The program then exits at the block 118.

In an anti-piracy software-firmware transfer system install process, the distribution media (e.g. USB Flash drive) works by “locking” to the computing device now containing the product after installation is performed. After install has been completed successfully, a unique identifier is written back to the invisible portion of the memory of the SCDS by the installer software.

At this point, the installation program will prevent further installations unless it is performed on a computing device whose ID matches that hidden within the SCDS or the hidden SCDS ID is blank.

To perform repairs, it is necessary that the hidden ID of the SCDS match the computing device ID.

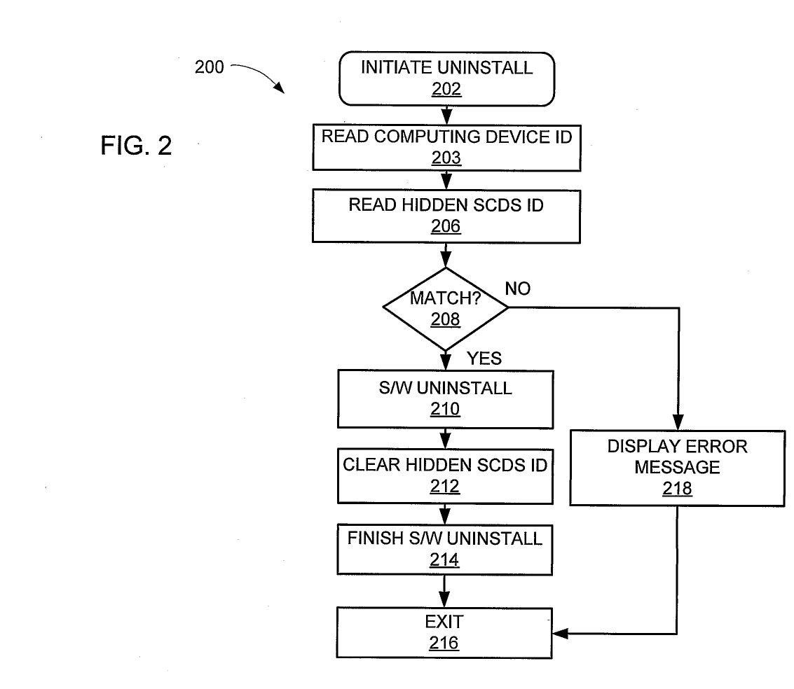

Referring now to FIG. 2, therein is shown a flow chart for an uninstall process 200 for a software-firmware transfer system in an embodiment of the present invention. The uninstall process 200 starts with the operator initiating an uninstall in a block 202.

The uninstall process 200 reads the computing device ID from the computing device in a block 204.

The uninstall process 200 reads the hidden SCDS ID from the SCDS in a block 206.

The computing device ID and the hidden SCDS ID are compared in a block 208 and, if the Ids match, the software is removed from the computing device in a software uninstall in a block 210.

Then, the hidden SCDS ID in the SCDS is cleared in a block 212, and the uninstall is finished in a block 214 and the program exits at a block 216.

If the computing device ID and the hidden SCDS ID do not match in the block 208, an error message is displayed in a block 218, and then the program exits at the block 216.

The anti-piracy software-firmware transfer system uninstall process must complete an uninstall. Software and/or firmware are typically licensed to a one or more users, not the computing device it is installed on. A partial uninstall cannot be aborted as this may cripple the installed software.

In the event that the customer wants to install the software and/or firmware on a second computing device (e.g., due to a new computing device purchase), the customer must first uninstall the software and/or firmware from the first computing device in order to clear the hidden SCDS ID. After the software has been uninstalled from the original computing device, it can be installed on the new computing device.

Trying to uninstall software with a SCDS with whose hidden SCDS ID has previously been reset will not work. So the conditions for uninstall are that the SCDS must be present and the hidden ID must match that of the original computing device.

Memory content in the SCDS or in the SCDS/media is encrypted in case the device is disassembled in order to gain direct access to the memory chip for the purpose of extracting its contents electrically. For example, unsoldering the memory chip and reading with an off-the-shelf programmer.

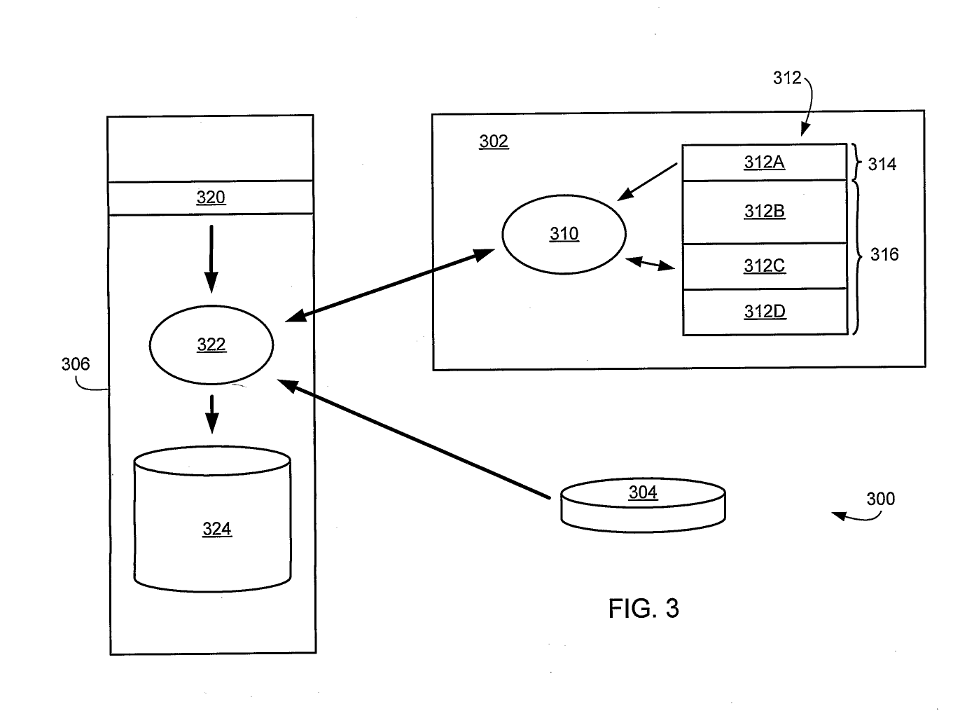

Referring now to FIG. 3, therein is shown a schematic of a software-firmware transfer system 300 using a separate SCDS 302 and separate distribution media 304 in another embodiment of the present invention.

The separate SCDS 302 contains a controller 310, such as a USB interface controller, and a memory 312.

The memory 312, such as a flash memory, contains installed.exe and uninstalled.exe files 312A in a visible memory space 314, and execution critical files 312B, optional authentication keys 312C, and a computing device ID 312D in an invisible memory space 316.

The separate distribution media 304, such as a compact disk, would contain application files ready for installation. In an alternate embodiment, the compact disk could also contain the installed.exe and uninstalled.exe files rather than the memory 312.

A computing device 306 has a computing device ID 320 in a hardware module, such as a hard drive, network card, microprocessor, etc.

The computing device 306 also has memory space containing an install/uninstall program 322. The install/uninstall program 322 is capable of taking application software from the separate distribution media 304 and installing or uninstalling the software onto a mass storage device 324, such as a computer hard disk drive or computing device memory.

The controller 310 controls data transfer between the memory 312 and the computing device 306.

While the separate distribution media 304 can be copied, the invisible memory space 316 cannot be copied, so unauthorized copying or software/firmware piracy cannot occur.

The software and/or firmware, including execution critical files, are installed with the separate SCDS 302 that accompanies the separate distribution media 304. Software, excluding the execution critical files, resides on the separate distribution media 304, such as a compact disk (CD). The software-firmware may be shipped in the same packaging as the separate SCDS 302 in order to activate application.

Commonly used methods can be used for software packaging. No special considerations are necessary. Files, if not hidden, may be copied. However, unauthorized use is prevented because the separate SCDS 302 is disabled once the software is installed. In other words for a single unit license, installation is blocked on other computing devices.

This process could also be extended to include multiple licenses for a given software- firmware. The SCDS would allow a fixed number of users before locking itself to any further installations.

For example, where the separate SCDS 302 is enabled for five users, the SCDS would keep track of five computing device IDs. In order for a sixth installation to occur, a removal must be performed on one of the existing computing devices.

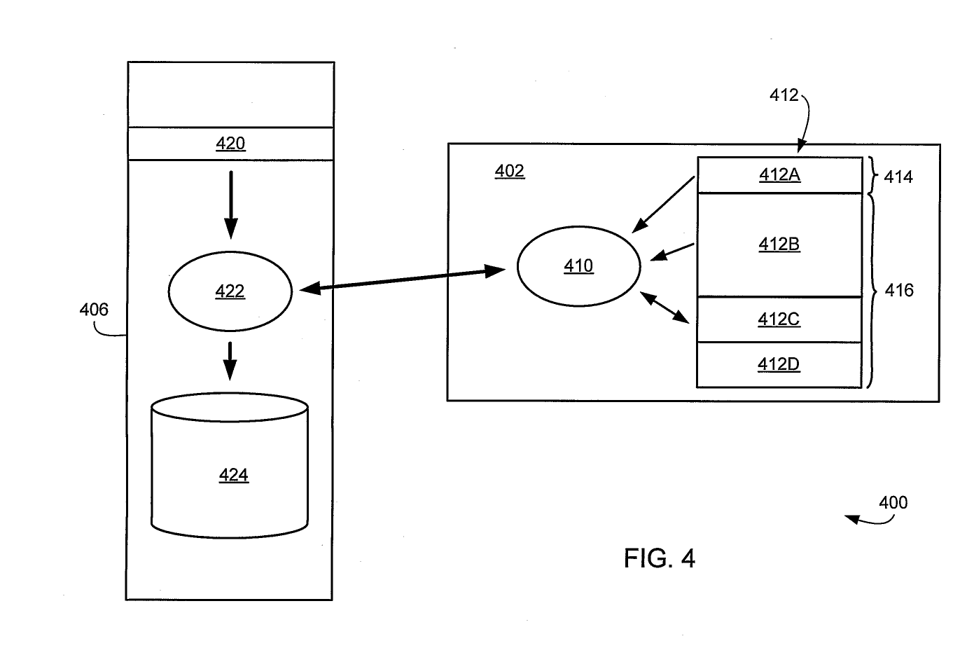

Referring now to FIG. 4, therein is shown a schematic of a software and/or firmware transfer system 400 using a SCDS 402 with integrated software media.

The SCDS 402 contains a controller 410, such as a USB interface controller, and a memory 412, which is the software media.

The memory 412, such as a flash memory, contains installed.exe and uninstalled.exe files 412A in a visible memory space 414, and execution critical files 412B, application software 412B, data 412B, help files 412B, optional authentication keys 412C, and a computing device ID 412D in an invisible memory space 416.

The SCDS 402 would have application software 412B ready for installation in a computing device 406 in the memory 412.

The computing device 406 has a computing device ID 420 in a hardware module, such as a hard drive, network card, microprocessor, etc.

The computing device 406 also has a memory space containing an install/uninstall program 422. The install/uninstall program 422 is capable of taking application software 412B from the memory 412 and installing or uninstalling the software onto a mass storage device 424, such as a computer hard disk drive or computing device memory.

The controller 410 controls data transfer between the memory 412 and the computing device 406.

While the separate distribution media 304 of FIG. 3 can be copied, the invisible memory space 316 cannot be copied. Similarly, the invisible memory space 416 of FIG. 4 that is the software distribution media of the integrated SCDS 402 cannot be copied. Since the invisible portions cannot be copied, unauthorized copying or software/firmware piracy cannot occur.
1. The distribution media 304 or the SCDS 402 support the following features:
   A visible portion of the distribution media that contains executables for initiating installation, release notes, etc., is visible to outside world.
   An invisible portion of the distribution media that is invisible to or protected from the outside world to hide an application.
   The media can be write protected to avoid accidental erasure.
   When connected to a processor system of a computing device, the operating system (O/S) “sees” only those files in the visible section.
   No operations (read, write, copy) can be performed on the invisible or protected section.
   Different embodiments can use any available communication protocol (e.g. RS-232, infra-red, radio, etc.) in addition to the USB protocol.
2. Installation software-firmware (smart media resident) knows how to access hidden files residing on the invisible portion of the distribution media. In other words, it performs the appropriate handshaking to extract hidden files and data from the invisible portion of the media. It should be noted that the install/uninstall software could reside on the computing device as well.
3. Identification code (ID) that can be associated with a single processor system.
4. The software and/or firmware can reside on the SCDS, for example in a USB Flash drive, or on separate distribution media such as a compact disk accompanied by the SCDS.
   It should be noted:
   The anti-piracy software-firmware transfer system of the present invention is not limited to personal computers and can be used to deliver content to embedded systems.
   The anti-piracy software-firmware transfer system of the present invention is not limited to USB devices and can be applied to any type of communication interface.
   Distribution files are not required to reside on an SCDS.
   Authentication keys are optional in order to provide an extra level of security and tracking. The anti-piracy software-firmware transfer system of the present invention does not require an authentication key to be fully functional.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A software-firmware transfer system comprising:
reading hidden computing device identification;
reading computing device identification; and
installing or uninstalling software only when the hidden computing device identification and the computing device identification match or the hidden computing device identification is blank.

2. The system as claimed in claim 1 further comprising displaying an error message when the hidden computing device identification and the computing device identification do not match.

3. The system as claimed in claim 1 further comprising retaining the hidden computing device identification when aborting the uninstalling software.

4. The system as claimed in claim 1 wherein installing software includes writing the computing device identification as the hidden computing device identification.

5. The system as claimed in claim 1 wherein uninstalling software includes clearing the hidden computing device identification.

6. The system as claimed in claim 1 installing software includes storing a plurality of hidden computing device identifications.

7. A software-firmware transfer system comprising:
reading hidden computing device identification from a controlled delivery system;
reading computing device identification from a computing device;
comparing the hidden computing device indentification and the computing device identification in the controlled delivery system; and
installing or uninstalling software in a computing device from a distibution media or a controlled delivery system only when the hidden computing device identification and the computing device identification from the computing device match or the hidden computing device identification is blank.

8. The system as claimed in claim 7 further comprising displaying an error message on the controlled delivery system when the hidden computing device identification and the computing device identification do not match.

9. The system as claimed in claim 7 further comprising retaining the hidden computing device identification in the controlled delivery system when aborting the uninstalling software.

10. The system as claimed in claim 7 wherein installing software includes writing the computing device identification as the hidden computing device identification in the controlled delivery system.

11. The system as claimed in claim 7 wherein uninstalling software includes clearing the hidden computing device identification in the controlled delivery system.

12. The system as claimed in claim 7 installing or uninstalling software includes storing a plurality of hidden computing device identifications in the controlled delivery system.

13. A software-firmware transfer system comprising:
a controlled delivery system including:
a controller; and
memory having:
a visible memory space for containing execution files, and an invisible memory space for containing hidden computing device identification.

14. The system as claimed in claim 13 wherein the memory includes an authentication key.

15. The system as claimed in claim 13 wherein the memory includes application software.

16. The system as claimed in claim 13 wherein:
the memory includes application software; and
further comprising:
a computing device including an install and uninstall program for installing or uninstalling the application software in the computing device.

17. The system as claimed in claim 13 further comprising:
distribution media including application software; and
a computing device including an install and uninstall for installing or uninstalling the application software in the computing device.

18. A software-firmware transfer system comprising:
a controlled delivery system including:
memory including:
a visible memory space for containing execution files, and
an invisible memory space for containing hidden computing device identification; and
a controller connected to the memory for controlling data transfers to and from the memory.

19. The system as claimed in claim 18 wherein the memory includes a memory space in the invisible memory space for an authentication key.

20. The system as claimed in claim 18 wherein the memory includes a memory space in the invisible memory space for application software.

21. The system as claimed in claim 18 wherein:
the memory includes a memory space in the invisible memory space for application software; and
further comprising:
a computing device including an install and uninstall program for installing or uninstalling the application software from the memory into the computing device.

22. The system as claimed in claim 18 further comprising:
distribution media including application software; and
a computing device including an install and uninstall program for installing or uninstalling the application software from the distribution media into the computing device.
